(19) United States
(12) Patent Application Publication
(10) Pub. No.: US 2023/0078090 A1
(43) Pub. Date: Mar. 16, 2023

(54) CONNECTOR ASSEMBLY

(71) Applicant: SUMITOMO WIRING SYSTEMS, LTD., Mie (JP)

(72) Inventors: Takuma HIBINO, Mie (JP); Harald LUTSCH, Wolfsburg (DE)

(21) Appl. No.: 17/800,508

(22) PCT Filed: Feb. 9, 2021
(86) PCT No.: PCT/JP2021/004747

§ 371 Date: Aug. 17, 2022

(30) Foreign Application Priority Data
Feb. 21, 2020 (JP) 2020-028763

(51) Int. Cl. H01R 13/6584; H01R 13/40; H01R 13/52; H01R 13/6463; H01R 13/6592

(52) U.S. Cl. CPC H01R 13/6584; H01R 13/40; H01R 13/52; H01R 13/6463; H01R 13/6592

(57) ABSTRACT

This connector assembly is provided with a communication cable, a tubular watertight plug, and a housing part, wherein the watertight plug is mounted on the outer circumferential surface of the communication cable, the housing part has a tubular inner circumferential surface covering the outer circumferential surface of the watertight plug and a raised section that projects out from the inner circumferential surface toward the watertight plug, and the raised section catches the watertight plug so as to oppose the slip-off direction of the watertight plug from the housing part.

### TECHNICAL FIELD

The present disclosure relates to a connector assembly.

This application claims priority based on Japanese Patent Application No. 2020-028763 filed Feb. 21, 2020, which is incorporated by reference herein in its entirety.

### BACKGROUND

Recently, for example, high-speed communication at 100 Mbps or more has been desired. A communication cable with a connector used for such high-speed communication is disclosed in Patent Document 1, for example.

The communication cable with a connector disclosed in Patent Document 1 is provided with a communication cable including a conductor, and a shield terminal attached to an end of the communication cable. The shield terminal is a connector module including a terminal unit and an outer conductor, which is a shield member that blocks electromagnetic waves. The terminal unit includes an inner conductor that functions as a terminal and a dielectric that functions as a connector member.

In the configuration in FIG. 1 of Patent Document 1, the shield terminal is housed in a first housing. A rubber stopper for watertightness is fitted into the end of the first housing on the communication cable side. The rubber stopper is fitted onto the outer circumference of a sheath of the communication cable.

### PRIOR ART DOCUMENT

### Patent Document

Patent Document 1: JP 2018-152174 A

### SUMMARY OF THE INVENTION

A connector assembly according to the present disclosure includes:

a communication cable;

a tubular watertight plug; and

a housing part, wherein

the watertight plug is mounted onto an outer circumferential surface of the communication cable,

the housing part has
a tubular inner circumferential surface covering an outer circumference of the watertight plug, and
a raised section projecting out from the inner circumferential surface toward the watertight plug, and

the raised section catches the watertight plug so as to oppose a slip-off direction of the watertight plug from the housing part.

### BRIEF DESCRIPTION OF THE DRAWINGS

FIG. 1 is a sectional view schematically illustrating a connector assembly according to Embodiment 1.

FIG. 2 is a view of the II-II section of the connector assembly in FIG. 1.

FIG. 3 is a perspective view of a communication cable with a connector provided in the connector assembly according to Embodiment 1.

FIG. 4 is an exploded perspective view illustrating a portion of the communication cable with a connector provided in the connector assembly according to Embodiment 1.

FIG. 5 is an exploded perspective view illustrating a portion of a connector member of the communication cable with a connector provided in the connector assembly according to Embodiment 1.

FIG. 6 is a perspective view of the shield member provided in the connector assembly according to Embodiment 1.

FIG. 7 is a perspective view of the shield member illustrated in FIG. 6 as seen from a different direction from FIG. 6.

FIG. 8 is a perspective view of a housing of the connector member provided in the connector assembly according to Embodiment 1.

FIG. 9 is a perspective view of the housing illustrated in FIG. 8 as seen from a different direction from FIG. 8.

FIG. 10 is a perspective view of a cover of the connector member provided in the connector assembly according to Embodiment 1.

FIG. 11 is a perspective view of the cover illustrated in FIG. 10 as seen from a different direction from FIG. 10.

FIG. 12 is a cross section of the communication cable with a connector provided in the connector assembly according to Embodiment 1.

FIG. 13 is a perspective view of a first terminal of the communication cable with a connector provided in the connector assembly according to Embodiment 1.

FIG. 14 is a perspective view as seen from the flat spring side, the view being obtained by rotating the first terminal illustrated in FIG. 13.

FIG. 15 is a schematic configuration diagram of a connector assembly according to an embodiment.

FIG. 16 is a perspective view of a housing of the connector member provided in the connector assembly according to Modification 1.

FIG. 17 is a perspective view of a cover of the connector member provided in the connector assembly according to Modification 1.

FIG. 18 is a cross section of a communication cable with a connector provided in the connector assembly according to Modification 1.

### DETAILED DESCRIPTION TO EXECUTE THE INVENTION

### Technical Problem

The watertight plug described above is normally secured to a first housing by a separately provided holder. For this reason, productivity is lowered in association with the increase in the number of parts.

One objective of the present disclosure is to provide a connector assembly with excellent productivity.

### Advantageous Effects of Present Disclosure

The connector assembly according to the present disclosure has excellent productivity.

### Description of Embodiments of Present Disclosure

First, embodiments of the present disclosure are listed below.

(1) A connector assembly according to an aspect of the present disclosure includes:

a communication cable;

a tubular watertight plug; and

a housing part, wherein

the watertight plug is mounted onto an outer circumferential surface of the communication cable,

the housing part has
a tubular inner circumferential surface covering an outer circumference of the watertight plug, and
a raised section projecting out from the inner circumferential surface toward the watertight plug, and

the raised section catches the watertight plug so as to oppose a slip-off direction of the watertight plug from the housing part.

The connector assembly suppresses movement of the watertight plug in the slip-off direction easily. This is because the housing part has the raised section. Accordingly, in the above connector assembly, a separate member such as a holder for securing the watertight plug is unnecessary. Therefore, the number of parts can be reduced, and the connector assembly has excellent productivity.

(2) In one exemplary aspect of the connector assembly,

the raised section has a first surface provided on a side opposite from the slip-off direction, and

the first surface has at least one of an orthogonal surface that is orthogonal to the slip-off direction or an inclined surface that is inclined toward the opposite side proceeding toward the watertight plug.

The connector assembly suppresses movement of the watertight plug in the slip-off direction more easily. This is because the raised section has the first surface, which causes the raised section to catch the watertight plug more easily.

(3) In one exemplary aspect of the connector assembly according to (2),

the watertight plug has a recess that is caught on the raised section, and

the recess has a surface that abuts the first surface of the raised section.

The connector assembly suppresses movement of the watertight plug in the slip-off direction even more easily. This is because the recess has a surface that abuts the first surface of the raised section, which causes the recess to be caught on the raised section easily.

(4) In one exemplary aspect of the connector assembly, the housing part has a plurality of raised sections.

The connector assembly suppresses movement of the watertight plug in the slip-off direction even more easily. This is because the housing part has a plurality of raised sections and therefore can catch the watertight plug at multiple locations.

(5) In one exemplary aspect of the connector assembly,

the communication cable includes a conductor, an insulating layer, and a sheath in order from the inside out,

the connector assembly includes
a first terminal electrically connected to the conductor exposed from the sheath,
a connector member that houses the first terminal, and
a tubular shield member that covers the outer circumference of the connector member and the outer circumference of the sheath, and

the watertight plug is mounted onto the outer circumferential surface of the sheath exposed from the shield member of the communication cable.

The connector assembly is suitable in a configuration including the communication cable, the first terminal, the connector member, and the shield member.

(6) In one exemplary aspect of the connector assembly according to (5), the communication cable is an unshielded twisted-pair cable.

The number of parts in the connector assembly can be reduced even if the communication cable is an unshielded twisted-pair cable. Unlike a shielded twisted-pair cable, an unshielded twisted-pair cable does not have a shielding layer between the insulating layer and the sheath. Consequently, for example, it is not possible to strip the leading-end side of the communication cable to expose the shielding layer from the sheath and form a stepped portion from the shielding layer and the sheath. In other words, it is not possible to catch the watertight plug on the stepped portion to suppress movement of the watertight plug in the slip-off direction. Therefore, in the case where the communication cable is an unshielded twisted-pair cable, a separate member such as the holder is normally necessary. In contrast, in the above connector assembly, the watertight plug can be caught on the raised section as described above. For this reason, in the above connector assembly, it is possible to make a separate member such as the holder unnecessary. Therefore, the connector assembly has excellent productivity even if the communication cable is an unshielded twisted-pair cable.

(7) In one exemplary aspect of the connector assembly according to (5) or (6), the shield member is a casting.

In the connector assembly, the shield member and the connector member are exceptionally easy to assemble. The reason is as follows. If the shield member is a casting, the shield member can be formed as a singular object rather than an assembly of multiple pieces. The singular shield member is easily attached to the connector member.

Moreover, the connector assembly has superior electromagnetic shielding properties. This is because the singular shield member can be produced without creating through-holes that act as passages for electromagnetic waves in the circumferential surface of the shield member.

(8) In one exemplary aspect of the connector assembly according to any one of (5) to (7),

the connector member includes a clamp projecting out from the inner circumferential surface of the connector member, and

the clamp bites into the communication cable.

In above connector assembly, the connector member does not slip off the end of the communication cable easily, even if the communication cable is subjected to vibration. This is because the connector member is firmly secured to the end of the communication cable by the clamp.

(9) In one exemplary aspect of the connector assembly according to any one of (5) to (8),

the first terminal is provided with
a tubular part into which a male terminal is inserted, and
a connecting part electrically connected to the conductor,

the tubular part is provided with a flat spring that presses against the outer circumferential surface of the male terminal inserted into the tubular part, and

the outer circumferential surface of the tubular part includes the outer surface of the flat spring.

In the connector assembly, the flat spring forms a portion of the tubular part. Such a first terminal has superior manufacturability compared to a conventional female terminal as described later.

### Detailed Description of Embodiments of Present Disclosure

Details regarding embodiments of the present disclosure will be described hereinafter with reference to the drawings. Identical reference signs in the drawings denote identically-named components. Note that the present invention is indicated by the claims and is not limited by the following examples, and all modifications within the scope of the claims and their equivalents are to be included in the scope of the present invention.

### Embodiment 1

[Connector Assembly]

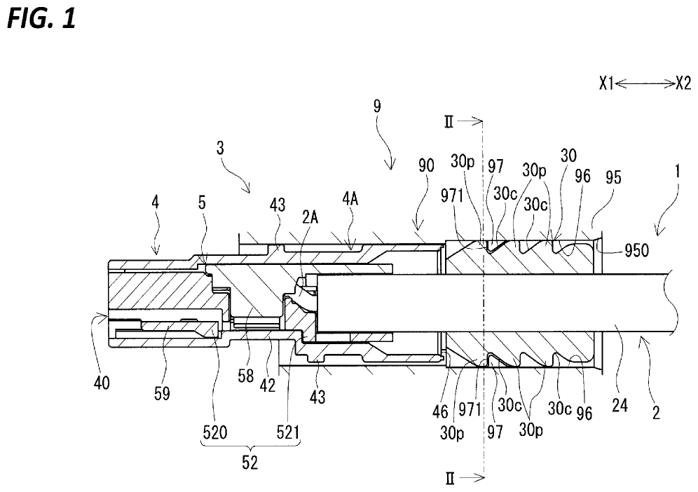

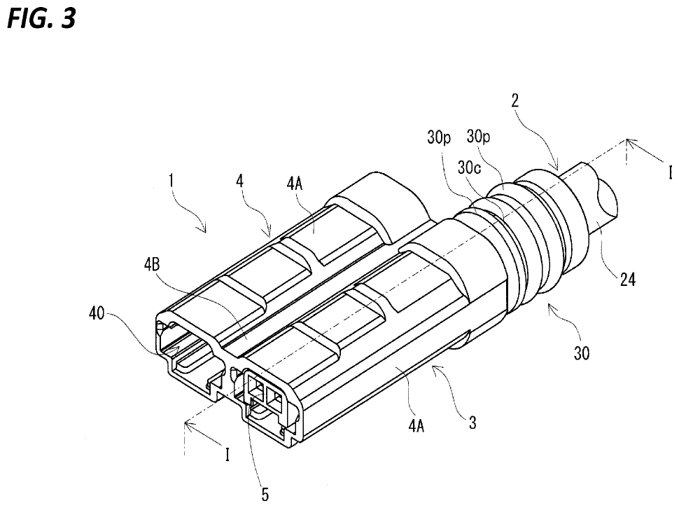

FIGS. 1 to 15 will be referenced to describe a connector assembly 9 according to Embodiment 1. As illustrated in FIG. 1, the connector assembly 9 is provided with a communication cable 2, a tubular watertight plug 30, and a housing part 95. The watertight plug 30 is mounted onto the outer circumferential surface of the communication cable 2. One characteristic of the connector assembly 9 in the present example is that the housing part 95 has a tubular inner circumferential surface 96 that covers the outer circumference of the watertight plug 30 and a specific raised section 97 that projects out from the inner circumferential surface 96 toward the watertight plug 30. Hereinafter, the main characteristic portion of the connector assembly 9, the configuration of portions related to the main characteristic portion, and the major advantageous effects will be described in order. After that, each component of other characteristic portions will be described in detail. FIG. 1 is a schematic sectional view of the connector assembly 9 taken along the cutting plane line I-I in FIG. 3. In FIG. 1, a sectional view of the sheath 24 of the communication cable 2 is not illustrated. Note that in FIG. 3, the outer circumferential surface of the housing part 95 is omitted from illustration out of convenience.

[Configuration of Main Characteristic Portion and Related Portions]

(Communication Cable)

The communication cable 2 illustrated in FIG. 1 is used for communication at 100 Mbps or more. The communication cable 2 is not particularly limited insofar as communication speeds of 100 Mbps or more can be ensured. The communication speed of the communication cable 2 is preferably equal to or greater than 1 Gbps. The communication cable 2 in the present example is an unshielded twisted-pair cable (UTP cable) conforming to the Ethernet standard. Ethernet is a registered trademark. The communication cable 2 is provided in a communication cable 1 with a connector described later.

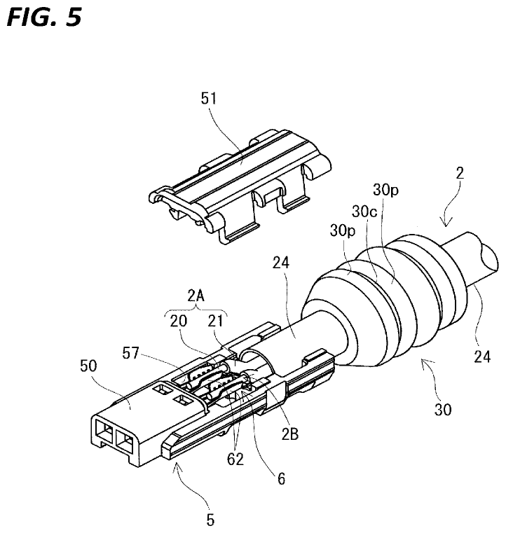

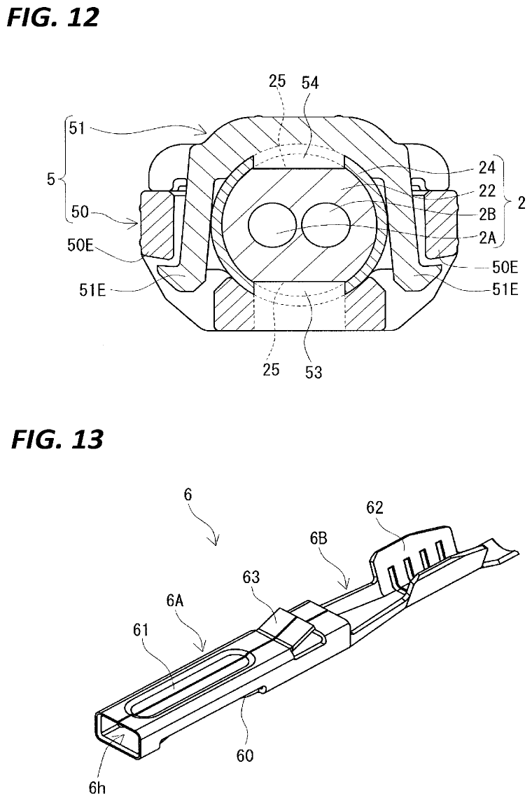

As illustrated in FIG. 5, the communication cable 2 in the present example is provided with a conductor 20, an insulating layer 21, and a sheath 24 in order from the inside out. As illustrated in FIG. 5, the communication cable 2 in the present example does not have to include an intervening layer between the insulating layer 21 and the sheath 24. Note that, as described later with reference to FIG. 12, the communication cable 2 may further include an intervening layer 22 between the insulating layer 21 and the sheath 24. As illustrated in FIG. 5, the communication cable 2 is provided with two electric wires 2A, 2B twisted together. Each of the electric wires 2A, 2B is provided with the conductor 20 and the insulating layer 21 that covers the outer circumference of the conductor 20. The sheath 24 covers the outer circumference of the two electric wires 2A, 2B. The sheath 24 is formed from an insulating resin such as polyvinyl chloride or polyethylene. Note that in the case where the communication cable 2 is provided with an intervening layer 22 as illustrated in FIG. 12, the two electric wires 2A, 2B twisted together are bundled into one by the intervening layer 22. In this case, the sheath 24 covers the outer circumference of the intervening layer 22.

As illustrated in FIG. 5, the end of the communication cable 2 is progressively stripped. On the leading-end side of the communication cable 2, the electric wires 2A, 2B are exposed from the sheath 24. The leading-end side of the communication cable 2 is the side in the X1 direction illustrated in FIG. 1, or in other words the left side of the page. As illustrated in FIG. 5, at the leading ends of the electric wires 2A, 2B, the conductor 20 is exposed from the insulating layer 21. A first terminal 6 described later is attached to each conductor 20.

As illustrated in FIG. 1, the communication cable 2 is inserted into the housing part 95 from an opening 950 described later in the housing part 95.

(Watertight plug)

As illustrated in FIG. 1, the watertight plug 30 deters the entry of environmental water into the leading-end side of the communication cable 2 from between the communication cable 2 and the housing part 95. Environmental water is water that is present in the environment where the connector assembly 9 is used, and includes moisture in the air. The watertight plug 30 is embedded into the space between the communication cable 2 and the housing part 95. The watertight plug 30 is a tubular member into which the communication cable 2 is inserted. The inner circumferential surface of the watertight plug 30 closely contacts the outer circumferential surface of the sheath 24. The watertight plug 30 is inserted into the housing part 95 from the opening 950 described later in the housing part 95.

<Placement>

The placement of the watertight plug 30 along the axial direction of the communication cable 2 is at a location exposed from a shield member 4 described later, and may be near an opening 46 described later in the shield member 4. In the present example, the end of the watertight plug 30 on the opening 46 side does not get inside the shield member 4. The end of the watertight plug 30 on the opening 46 side may also be referred to as the leading-end side of the watertight plug 30. The leading-end side of the watertight plug 30 may or may not be flush with the opening 46 in the shield member 4. The leading-end side of the watertight plug 30 is the side in the X1 direction illustrated in FIG. 1, or in other words the left side of the page.

The watertight plug 30 is caught on a raised section 97 of the housing part 95 described later. Due to the catching by the raised section 97, the watertight plug 30 is positioned at the above placement. Accordingly, the watertight plug 30 does not easily move in the direction going toward the base-end side of the communication cable 2, or in other words the slip-off direction from the opening 950 in the housing part 95, and does not slip out of the opening 950 in the housing part 95 easily. Therefore, the entry of environmental water into the leading-end side of the communication cable 2 from between the communication cable 2 and the housing part 95 is deterred. The base-end side of the communication cable 2 is the side in the X2 direction illustrated in FIG. 1, or in other words the right side of the page. The slip-off direction is the X2 direction illustrated in FIG. 1. Also, since the watertight plug 30 is caught on the raised section 97, a separate holder for securing the watertight plug 30 at a desired position is unnecessary. For this reason, the number of parts can be reduced, thereby improving the productivity of the connector assembly 9.

<Recess>

The watertight plug 30 preferably has a recess 30c that is caught on the raised section 97 of the housing part 95. By having the recess 30c, movement of the watertight plug 30 in the slip-off direction is suppressed more easily. The recess 30c is provided so as to be sunken from the outer circumferential surface of the watertight plug 30 toward the inner circumferential surface.

There may be one or multiple recesses 30c. In the case where there is a single recess 30c, the recess 30c may be provided annularly throughout the entire circumferential direction on the outer circumferential surface of the watertight plug 30, or provided locally in the circumferential direction on the outer circumferential surface of the watertight plug 30. In the case where there are multiple recesses 30c, the plurality of recesses 30c are provided spaced apart from each other in at least one of the circumferential direction or the axial direction of the watertight plug 30. The respective intervals between recesses 30c adjacent in the circumferential direction may or may not be equal intervals. The respective intervals between recesses 30c adjacent in the axial direction may or may not be equal intervals.

In the present example, a plurality of annular recesses 30c are provided side by side in the axial direction. In the present example, the recess 30c on the leading-end side of the watertight plug 30 from among the plurality of annular recesses 30c is caught on the raised section 97. The recesses 30c are provided between annular ridges 30p. The ridges 30p are provided on the outer circumferential surface of the watertight plug 30.

The ridges 30p are provided at positions farther outward than the outer circumferential surface of the shield member 4 described later. For this reason, the ridges 30p have a maximum outer diameter that is greater than the maximum outer diameter of the shield member 4. The maximum outer diameter of the ridges 30p refers to the maximum outer diameter when not compressed by the inner circumferential surface 96 of the housing part 95. In the state in which the watertight plug 30 is housed inside the housing part 95, the ridges 30p are pressed against the inner circumferential surface 96 of the housing part 95 and thereby closely contact the inner circumferential surface 96. As described above, the inner circumferential surface of the watertight plug 30 and the outer circumferential surface of the communication cable 2 are in close contact. Additionally, the ridges 30p and the inner circumferential surface 96 of the housing part 95 are in close contact. Accordingly, the entry of environmental water into the leading-end side of the communication cable 2 from between the communication cable 2 and the housing part 95 is deterred. Moreover, the close contact between the ridges 30p and the inner circumferential surface 96 of the housing part 95 causes the recess 30c to be caught on the raised section 97 described later adequately. For this reason, the watertight plug 30 does not move in the slip-off direction easily. Also, by alternately providing the recesses 30c and the ridges 30p, the creepage distance from the opening 950 in the housing part 95 to the shield member 4, that is, the path of intrusion by environmental water, can be lengthened. For this reason, the intrusion of environmental water into the leading-end side of the communication cable 2 can be deterred effectively. Note that FIG. 1 illustrates a state in which the ridges 30p are not being pressed by the inner circumferential surface 96.

The recess 30c preferably has a specific first surface. The first surface of the recess 30c abuts a first surface 971 described later of the raised section 97. The first surface of the recess 30c is provided on the side opposite from the slip-off direction, or in other words on the leading-end side of the watertight plug 30. The side opposite from the slip-off direction is the side in the X1 direction illustrated in FIG. 1, or in other words the left side of the page. The first surface of the recess 30c has at least one of an orthogonal surface or an inclined surface. The orthogonal surface is a surface orthogonal to the slip-off direction. The inclined surface is a surface that is inclined in the slip-off direction proceeding toward the outer circumference of the watertight plug 30. In other words, the inclined surface is a surface extending such that the recess 30c deepens proceeding toward the leading-end side of the watertight plug 30. By configuring the recess 30c to have the first surface, the recess 30c is caught on the raised section 97 easily.

The longitudinal-sectional shape of the recess 30c in the present example is a shape in accordance with the longitudinal-sectional shape of the raised section 97 described later. The longitudinal-sectional shape refers to the sectional shape obtained when taking a section along the axial direction of the watertight plug 30 in the state before the watertight plug 30 is pressed by the inner circumferential surface 96 of the housing part 95. Specifically, the longitudinal-sectional shape of the recess 30c in the present example is approximately a right triangle.

The recess 30c in the present example is formed by a first surface provided on the leading-end side of the watertight plug 30 and a second surface provided on the trailing-end side of the watertight plug 30. The first surface is formed by an orthogonal surface orthogonal to the axial direction of the watertight plug 30. The second surface is joined to the orthogonal surface on the inner circumferential side of the watertight plug 30. The second surface is formed by an inclined surface that is inclined toward the outer circumference of the watertight plug 30 proceeding toward the trailing-end side of the watertight plug 30.

<Constituent Material>

The constituent material of the watertight plug 30 is typically rubber. The rubber may be natural rubber or synthetic rubber, for example. Silicone rubber is suitable as the rubber. Silicone rubber is a relatively soft rubber. Accordingly, elastic deformation of the watertight plug 30 formed from silicone rubber is easy. The watertight plug 30 in the present example is a molded article of silicone rubber.

(Housing Part)

The housing part 95 houses the communication cable 2 and the watertight plug 30. The communication cable 2 and the watertight plug 30 are inserted into the housing part 95 from the opening 950 in the housing part 95. The opening 950 in the housing part 95 is provided on the base-end side of the communication cable 2. The housing part 95 is provided on an outer housing 90 described later. The housing part 95 has a tubular inner circumferential surface 96 covering the outer circumference of the watertight plug 30 and a raised section 97 projecting out from the inner circumferential surface 96 toward the watertight plug 30.

<Raised Section>

The raised section 97 catches the watertight plug 30 so as to oppose the slip-off direction. In other words, the raised section 97 restricts movement of the watertight plug 30 in the slip-off direction and keeps the watertight plug 30 from slipping out of the opening 950 in the housing part 95. The raised section 97 in the present example catches the recess 30c of the watertight plug 30. The raised section 97 is integrated with the housing part 95.

There may be one or multiple raised sections 97. In the case where there is a single raised section 97, the raised section 97 may be provided annularly throughout the entire circumferential direction of the inner circumferential surface 96, or provided locally in the circumferential direction of the inner circumferential surface 96. In the case where there are multiple raised sections 97, the recess 30c is caught on the raised section 97 easily. The plurality of raised sections 97 are provided spaced apart from each other in the circumferential direction of the inner circumferential surface 96. The intervals between raised sections 97 adjacent in the circumferential direction may or may not be equal intervals. The raised section 97 can be produced by forming the outer housing 90 using a core with a recess corresponding to the raised section 97. The core is separable in the axial direction of the housing part 95.

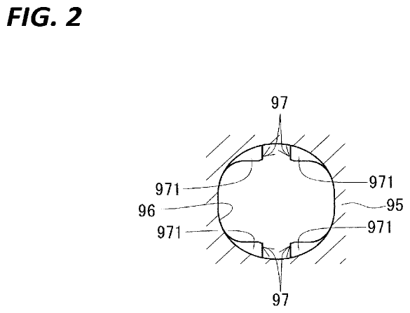

As illustrated in FIG. 2, there are four raised sections 97 in the present example. In FIG. 2, the watertight plug 30 and communication cable 2 inside the housing part 95 are omitted from illustration out of convenience. The four raised sections 97 are spaced apart by a prescribed interval in the circumferential direction of the inner circumferential surface 96 such that each first surface 971 described later is positioned in the same plane. In other words, when the four raised sections 97 are treated as a single raised section group, the single raised section group is provided at a single location in the axial direction of the inner circumferential surface 96. The respective intervals between the raised sections 97 adjacent in the circumferential direction are unequal intervals.

The raised section 97 preferably has a specific first surface 971. The first surface 971 of the raised section 97 abuts the first surface of the recess 30c described above. The first surface 971 of the raised section 97 is provided on the side opposite from the slip-off direction, or in other words on the leading-end side of the watertight plug 30. The first surface 971 of the raised section 97 has at least one of an orthogonal surface or an inclined surface. The orthogonal surface is a surface orthogonal to the slip-off direction. The inclined surface is a surface that is inclined on the leading-end side of the watertight plug 30 proceeding toward the watertight plug 30. In other words, the inclined surface is a surface that is inclined so as to project inward into the housing part 95 proceeding toward the leading-end side of the watertight plug 30. By configuring the raised section 97 to have the first surface 971, the raised section 97 catches the recess 30c easily.

The longitudinal-sectional shape of the raised section 97 can be selected as appropriate. The longitudinal-sectional shape refers to the sectional shape obtained when taking a section along the axial direction of the inner circumferential surface 96 of the housing part 95. The longitudinal-sectional shape of the raised section 97 in the present example is approximately a right triangle.

The raised section 97 in the present example is formed by the first surface 971 provided on the leading-end side of the watertight plug 30 and a second surface provided on the trailing-end side of the watertight plug 30. The first surface 971 is formed by an orthogonal surface orthogonal to the axial direction of the watertight plug 30. The second surface is joined to the orthogonal surface on the watertight plug 30 side. The second surface is formed by an inclined surface that is inclined away from the watertight plug 30 proceeding toward the trailing-end side of the watertight plug 30. By configuring the raised section 97 to have the second surface, the watertight plug 30 is easily inserted into a prescribed placement from the opening 950 in the housing part 95. By configuring the raised section 97 to have the first surface 971, the raised section 97 catches the recess 30c easily.

[Effects of Main Characteristic Portion]

In the connector assembly 9 in the present example, by configuring the watertight plug 30 to have the recess 30c and the housing part 95 to have the raised section 97, the raised section 97 catches the recess 30c easily. The watertight plug 30 with the recess 30c easily caught on the raised section 97 does not move in the slip-off direction easily. Accordingly, in the connector assembly 9, a separate member such as a holder for securing the watertight plug 30 is unnecessary. Therefore, the number of parts in the connector assembly 9 can be reduced. The connector assembly 9 has excellent productivity.

In particular, the number of parts in the connector assembly 9 in the present example can be reduced even if the communication cable 2 is an unshielded twisted-pair cable. An unshielded twisted-pair cable does not have a shielding layer between the insulating layer 21 and the sheath 24. Consequently, for example, it is not possible to strip the leading-end side of the communication cable to expose the shielding layer from the sheath and form a stepped portion from the shielding layer and the sheath. In other words, it is not possible to catch the watertight plug on the stepped portion to suppress movement of the watertight plug in the slip-off direction. Therefore, in the case where the communication cable 2 is an unshielded twisted-pair cable, a separate member such as the holder is normally necessary. In contrast, in the connector assembly 9 in the present example, movement of the watertight plug 30 in the slip-off direction is suppressed easily by the recess 30c and the raised section 97 as described above. For this reason, in the connector assembly 9 in the present example, it is possible to make a separate member such as the holder unnecessary. Therefore, the connector assembly 9 in the present example has excellent productivity even if the communication cable 2 is an unshielded twisted-pair cable.

[Description of Components Including Other Characteristic Portions]

(Communication Cable with Connector)

A communication cable 1 with a connector to be used for high-speed wired communication in an automobile will be described on the basis of FIGS. 1 to 14.

FIG. 1 does not illustrate a sectional view but rather an external view of the sheath 24 of the communication cable 2.

FIGS. 5, 13, and 14 illustrate states in which a wire barrel 62 is open in a first terminal 6 described later. When the communication cable 1 with a connector is in the assembled state, the wire barrel 62 is in a folded state, or in other words a closed state.

Note that the vertical direction in FIGS. 1 to 5 is not necessarily aligned with up and down in the automobile.

Also, in this specification, a cross section refers a sectional view taken in the plane orthogonal to the axial or longitudinal direction of the communication cable 1 with a connector and each member such as the shield member 4.

<Overview>

As illustrated in FIG. 1, the communication cable 1 with a connector is provided with the communication cable 2 described above and a connector module 3. The connector module 3 is provided on an end of the communication cable 2. The communication cable 1 with a connector in the present example is a pigtail cable in which the connector module 3 is provided on only one end of the communication cable 2. Unlike the present example, the communication cable 1 with a connector may also be a jumper cable in which the connector module 3 is provided on both ends of the communication cable 2. The connector module 3 is provided with a shield member 4, a connector member 5, and a first terminal 6. Hereinafter, the shield member 4, connector member 5, and first terminal 6 will be described in order.

(Shield Member)

As illustrated in FIG. 1, the shield member 4 is a member that provides shielding from electromagnetic waves radiated from the first terminal 6 and the conductor 20 illustrated in FIG. 5, and from electromagnetic waves originating outside the shield member 4. As illustrated in FIG. 3, the shield member 4 is configured into a tubular shape that cover the outer circumference of the connector member 5. The shield member 4 is long enough to internally accommodate an entire connector member 5.

<Overall Configuration>

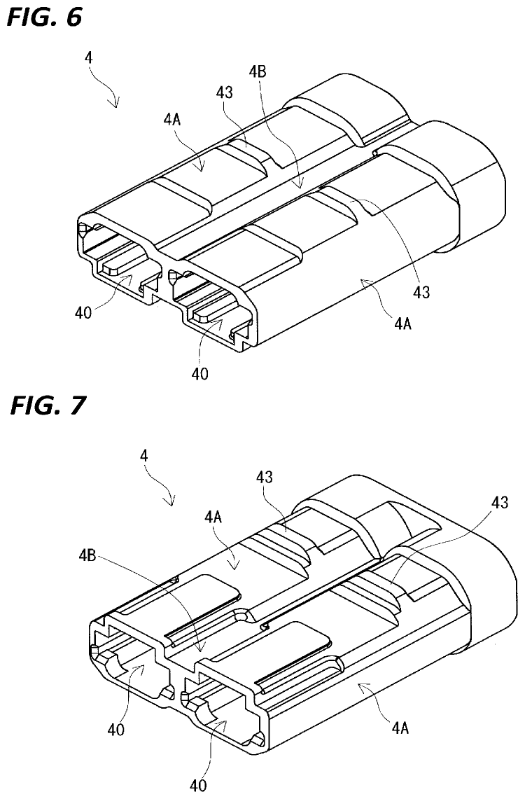

As illustrated in FIGS. 6 and 7, the shield member 4 in the present example is provided with two tubular bodies 4A and a connecting part 4B. The two tubular bodies 4A are arranged side by side with the axes parallel to each other. The connecting part 4B is provided between the two tubular bodies 4A. The connecting part 4B connects the tubular bodies 4A along the axial directions thereof. In other words, the shield member 4 is a singular object in which the two tubular bodies 4A and the connecting part 4B are unified.

Each of the two tubular bodies 4A is long enough to internally accommodate an entire connector member 5. The two tubular bodies 4A both have a continuous circumferential wall. The circumferential wall does not have holes penetrating through the inside and outside thereof. The connecting part 4B is a wall that partitions the adjoining tubular bodies 4A, so to speak. FIG. 3 illustrates a state in which the connector member 5 is housed in one of the tubular bodies 4A. In actuality, when the communication cable 1 with a connector is in the assembled state, one connector member 5 is housed in each of the two tubular bodies 4A. In other words, the shield member 4 in the present example has a function of bundling two communication cables 2 into one and a function of collectively shielding the ends of the two communication cables 2 from electromagnetic waves. Unlike the present example, the shield member 4 may also be formed from a single tubular body 4A. Alternatively, the shield member 4 may also be formed by connecting three or more tubular bodies 4A with respective connecting parts 4B.

<Mating Terminal Side>

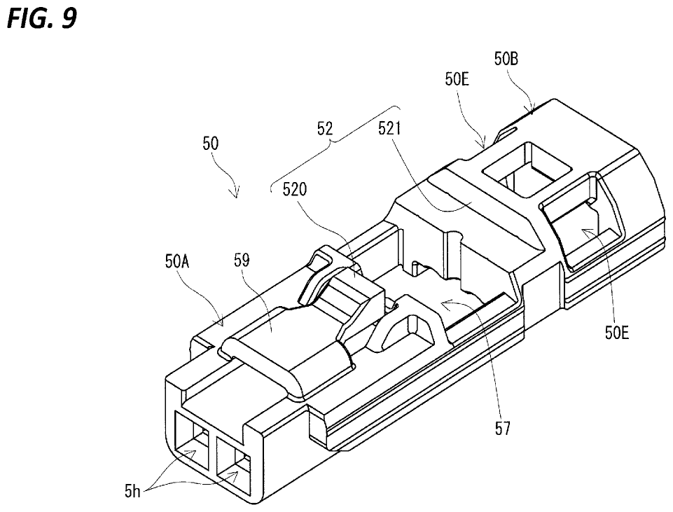

In the present example, as illustrated in FIG. 1, a shield-side engaging part 42 that engages with the outer circumference of the connector member 5 is provided inside each tubular body 4A on the side where a mating terminal is inserted. The shield-side engaging part 42 has a certain length along the axial direction of the tubular body 4A. The shield-side engaging part 42 in the present example is an engaging raised section that projects out from the inner circumferential surface of the shield member 4. The shield-side engaging part 42 engages with a connector-side engaging part 52, to be described later with reference to FIG. 9, of the connector member 5. More specifically, the shield-side engaging part 42 is fitted into the space between an elastic protrusion 520 and a stepped portion 521 of the connector-side engaging part 52. The engagement between the shield-side engaging part 42 and the connector-side engaging part 52 will be described later. Unlike the present example, the shield-side engaging part 42 may also be an engaging recessed section.

<Communication Cable Side>

As illustrated in FIG. 1, an opening 46 is provided on the side of the shield member 4 opposite from an opening 40 in each tubular body 4A. The side opposite from the opening 40 is the side in the X2 direction illustrated in FIG. 1, or in other words the right side of the page. An end of the communication cable 2 is inserted into the opening 46.

<Manufacture>

The shield member 4 may be a casting. A casting is produced by filling a mold with a metal in a molten state, that is, molten metal, and then cooling the mold and the metal. The shield member 4 in the present example is a die-cast material, which is one example of a casting. A die-cast material is produced by forcing molten metal under pressure into a mold.

The shield member 4 in the present example does not have through-holes that act as passages for electromagnetic waves in the circumferential surface thereof. This is because the shield member 4 formed from a casting can be produced without providing through-holes. In other words, the connector module 3 is provided with the shield member 4 in the present example that does not have through-holes in the circumferential surface, and therefore has excellent electromagnetic shielding properties. The communication cable 1 with a connector in the present example having excellent shielding properties is suitable for high-speed communication at 100 Mbps or more.

The shield member 4 formed from a casting can be attached to the connector member 5 easily. This is because the shield member 4 formed from a casting does not necessitate a divided structure. Consequently, the connector module 3 and communication cable 1 with a connector provided with the shield member 4 in the present example have excellent productivity.

The shield member 4 formed from a casting can be attached to the connector member 5 precisely. This is because when attaching the shield member 4 formed from a casting to the connector member 5, there is the casting tolerance when casting the shield member 4, and there is no assembly tolerance. Unlike the present example, if a shield member obtained as a combination of two stamped pieces, for example, is attached to the connector member 5, it will be necessary to consider both the machining tolerance of the member during the stamping and the assembly tolerance when combining the two pieces. Consequently, it is difficult to attach a shield member obtained as a combination of two stamped pieces to the connector member 5 precisely.

The shield member 4 formed from a casting tends to be thicker compared to a stamped shield member. This is because it is necessary to consider the fillability by which molten metal fills the mold during the production of the shield member 4. If the shield member 4 is thick, the size and mass of the shield member 4 may be increased. For this reason, the minimum value of the thickness of the shield member 4 is preferably equal to or greater than 0.25 mm and less than or equal to 1.0 mm.

If the minimum value of the thickness of the shield member 4 is equal to or greater than 0.25 mm, the fillability of molten metal during the production of the shield member 4 is not degraded easily. Moreover, adequate strength of the shield member 4 is ensured. On the other hand, setting the minimum value of the thickness of the shield member 4 to be less than or equal to 1.0 mm keeps the shield member 4 from being bulky and heavy. For this reason, a compact and lightweight shield member 4 is attained easily. The minimum value of the thickness of the shield member 4 is preferably equal to or greater than 0.3 mm and less than or equal to 0.9 mm.

Preferably, the shield member 4 is provided with locally thick-walled sections 43. In the present example, the thick-walled sections 43 are formed on each of the mutually facing surfaces of the shield member 4 illustrated in FIGS. 6 and 7. By providing the shield member 4 with the thick-walled sections 43, the fillability of molten metal is improved during the casting of the shield member 4. Moreover, the strength of the shield member 4 is improved by the thick-walled sections 43.

<Constituent Material>

The constituent material of the shield member 4 may be a metal with a high electrical conductivity. The constituent material is preferably an alloy, more preferably a zinc alloy. Zinc alloys are alloys in which the most abundant element in the alloy is zinc (Zn). Specific zinc alloys include alloys containing, besides zinc, at least one element selected from the group consisting of aluminum (Al), magnesium (Mg), iron (Fe), lead (Pb), cadmium (Cd), and tin (Sn). Zinc alloys are suitable as the constituent material for the shield member 4 due to their excellent electrical conductivity and strength, and their low cost. Moreover, molten zinc alloys have low viscosity, making it easy for the molten metal to spread into narrow spaces in the mold in the case where the shield member 4 is a casting as described above. Consequently, by using a zinc alloy, the thin-walled shield member 4 is produced easily with high dimensional accuracy.

(Connector Member)

As illustrated in FIG. 5, the connector member 5 houses the first terminal 6 described later. The connector member 5 in the present example is provided with a housing 50 and a cover 51. The constituent materials of the housing 50 and the cover 51 are both an electrically insulating material, typically a resin. The resin may be polybutylene terephthalate, polyamide, or polyethylene.

<Housing>

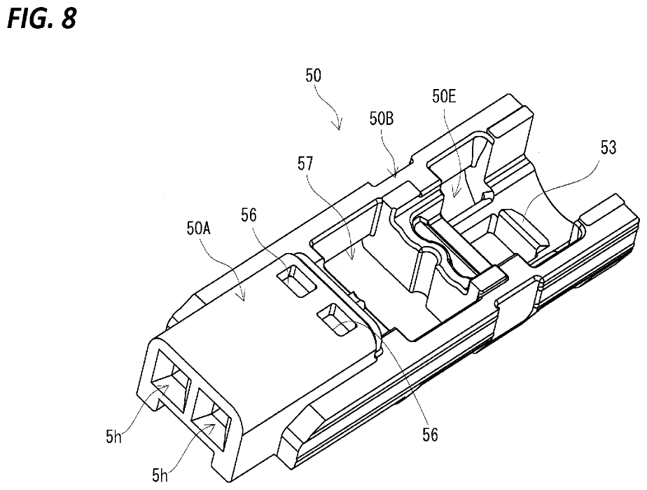

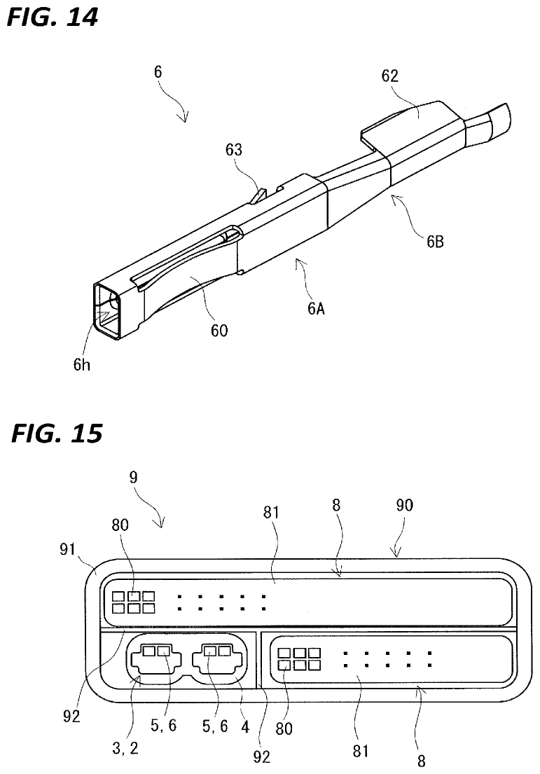

As illustrated in FIGS. 8 and 9, the housing 50 is provided with a connector tube 50A and a base SOB. A tubular part 6A illustrated in FIGS. 13 and 14 is mainly inserted into the connector tube 50A. The tubular part 6A is the leading end of the first terminal 6. The base SOB underpins the connection point between the first terminal 6 illustrated in FIG. 5 and the conductor 20 of the communication cable 2. The base SOB is open on the upper side of the page in FIG. 8.

As illustrated in FIGS. 8 and 9, the connector tube 50A is provided with two insertion holes 5h. The first terminal 6 illustrated in FIG. 5 is inserted into each insertion hole 5h. The connector tube 50A is provided with engaging recesses 56 that communicate with the insertion holes 5h from the outer circumferential surface. The engaging recesses 56 engage with an engaging tab 63 of the first terminal 6 described later with reference to FIG. 13. In the present example, the engaging recesses 56 are engaging holes that penetrate through the inside and outside. Note that the engaging recesses 56 may also be indentations formed in the inner circumferential surface of the insertion holes 5h.

The base SOB is provided with housing-side engaging parts 50E and a through-hole 57. The housing-side engaging parts 50E are used to join the housing 50 and the cover 51 illustrated in FIG. 5. The housing-side engaging parts 50E in the present example are configured by engaging holes penetrating through the base SOB. The through-hole 57 is provided at a position corresponding to the connection points between the first terminal 6 illustrated in FIG. 5 and the conductor 20. The through-hole 57 is provided to ease the work of connecting the first terminal 6 and the conductor 20. The through-hole 57 is also used to join the housing 50 and the cover 51, similarly to the housing-side engaging parts 50E. Unlike the present example, the housing-side engaging parts 50E may also be engaging tabs.

<Cover>

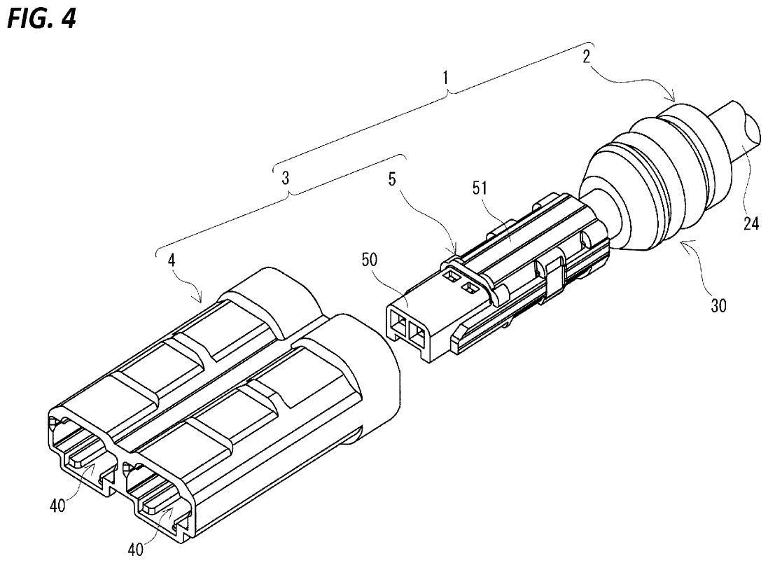

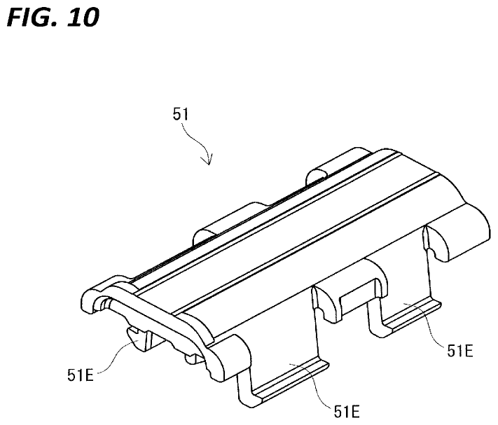

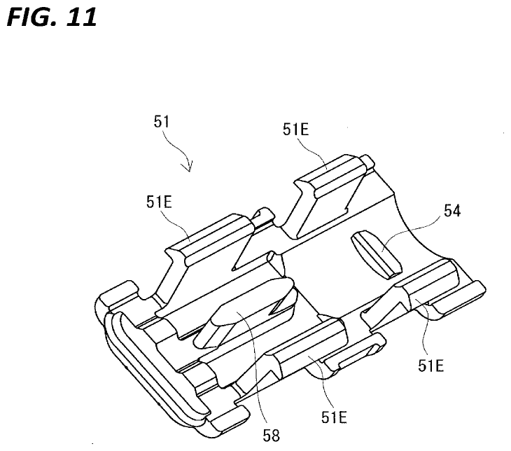

As illustrated in FIGS. 4 and 5, the cover 51 is a member that covers the opening in the base 50B of the housing 50 illustrated in FIG. 8. As illustrated in FIGS. 10 and 11, the cover 51 is provided with a plurality of cover-side engaging parts 51E. The cover-side engaging parts 51E in the present example are engaging tabs. The cover-side engaging parts 51E formed as engaging tabs are respectively fitted into the housing-side engaging parts 50E formed as engaging holes and the through-hole 57 illustrated in FIG. 8. Due to the engagement of the engaging tabs and the engaging holes, the cover 51 is firmly secured to the housing 50. Unlike the present example, the housing-side engaging parts 50E may be configured as engaging tabs and the cover-side engaging parts 51E may be configured as engaging holes.

As illustrated in FIG. 11, the cover 51 is provided with a partition 58 that projects out from the inner circumferential surface thereof. In the present example, as described above, the communication cable 2 is an unshielded twisted-pair cable and is provided with two electric wires 2A, 2B as illustrated in FIG. 5. For this reason, two connection points between the first terminal 6 and the conductor 20 of the communication cable 2 are provided side by side, as illustrated in FIG. 5. As illustrated in FIG. 1, the partition 58 is interposed between the connection points arranged side by side. The interposition of the partition 58 ensures insulation between the connection points arranged side by side.

<Configuration for Securing Communication Cable to Connector Member>

As illustrated in FIGS. 8 and 11, the connector member 5 in the present example is internally provided with clamps 53 and 54. As illustrated in FIG. 12, the clamp 53 is a portion of the connector member 5 that projects out from the inner circumferential surface of the housing 50 toward the communication cable 2. The clamp 54 is a portion of the connector member 5 that projects out from the inner circumferential surface of the cover 51 toward the communication cable 2. FIG. 12 is a sectional view of the communication cable 1 with a connector taken in the direction orthogonal to the longitudinal direction at the position where the clamps 53 and 54 are provided. FIG. 12 illustrates a configuration in which the communication cable 2 is provided with the intervening layer 22 between the insulating layer 21 and the sheath 24 out of convenience, but as described above, the intervening layer 22 does not have to be provided.

As illustrated in FIG. 8, the clamp 53 is provided on the inner circumferential surface of the base 50B of the housing 50. Specifically, the clamp 53 is provided in the floor portion of the base 50B that faces the sheath 24 of the communication cable 2 illustrated in FIG. 1. The clamp 53 in the present example is a wide tab-shaped member that is long in the width direction of the base 50B. The shape of the clamp 53 as seen from the side is approximately a right triangle. The clamp 53 is configured to project out by an increasing amount proceeding from the rim of the housing 50 toward the connector tube 50A.

As illustrated in FIG. 11, the clamp 54 is provided in a portion of the inner circumferential surface of the cover 51 excluding the cover-side engaging parts 51E, at a position facing the clamp 53 illustrated in FIG. 8. The clamp 54 in the present example is a tab-shaped member of substantially the same width as the clamp 53. The shape of the clamp 54 as seen from the side is approximately a scalene triangle. The amount by which the clamp 54 projects increases and then decreases proceeding from the rim of the cover 51 toward the partition 58. The inclination angle of the surface of the clamp 54 on the partition 58 side is greater than the inclination angle of the surface of the clamp 54 on the communication cable 2 side.

As illustrated in FIG. 12, the clamps 53 and 54 bite into the intervening layer 22 from the outer circumference of the sheath 24 of the communication cable 2. In the present example, notches 25 are provided in the intervening layer 22. The clamps 53 and 54 are fitted into each notch 25. Unlike the present example, the clamps 53 and 54 may also be configured to press against the outer circumference of the intervening layer 22 and bite into the intervening layer 22 when the housing 50 and the cover 51 are engaged. Regardless of whether the notches 25 exist, by having the clamps 53 and 54 bite into the intervening layer 22, the connector member 5 is firmly secured to the end of the communication cable 2.

Note that even if the sheath 24 is deformed by the clamps 53 and 54, the shielding properties of the communication cable 1 with a connector are not lowered. This is because in the communication cable 1 with a connector in the present example, the outer circumference of the connector member 5 is surrounded by the shield member 4 that has excellent shielding properties.

Since the communication cable 2 is gripped by the clamps 53 and 54, the connector member 5 in the present example can be relatively short. With a configuration in which the communication cable 2 is gripped by the clamps 53 and 54, the length of the connector member 5 can be kept to 22 mm or less, for example. If the length of the connector member 5 is short, the length of the shield member 4 covering the connector member 5 can also be short. If the length of the metal shield member 4 is short, the shield member 4 is more lightweight. For this reason, the connector module 3 is more lightweight. Preferably, the length of the connector member 5 is less than or equal to 20 mm. The lower limit on the length of the connector member 5 may be approximately 10 mm, for example.

<Securing Connector Member to Shield Member>

As illustrated in FIG. 1, the connector member 5 is provided with a connector-side engaging part 52 that engages with the shield-side engaging part 42 of the shield member 4. As illustrated in FIG. 9, the connector-side engaging part 52 in the present example is provided on the outer circumferential surface of the housing 50. Specifically, the connector-side engaging part 52 includes an elastic protrusion 520 provided on the connector tube 50A and a stepped portion 521 provided on the base SOB.

The elastic protrusion 520 is supported in a cantilevered configuration on the trailing end, or in other words the end on the base SOB side, of an arched portion 59 provided on the outer circumferential surface of the connector tube 50A. The surface of the elastic protrusion 520 on the leading-end side of the connector member 5, or in other words the surface on the opposite side from the base SOB, is an inclined surface. Additionally, the surface of the elastic protrusion 520 on the base SOB side is a perpendicular surface.

The stepped portion 521 is a locally thick portion of the base 50B. The surface of the stepped portion 521 on the leading side of the connector member 5 is a perpendicular surface.

As illustrated in FIG. 4, the connector member 5 is inserted into the shield member 4 from the opening 46 illustrated in FIG. 1. When the connector member 5 is inserted into the shield member 4, the elastic protrusion 520 illustrated in FIG. 9 contacts the shield-side engaging part 42 illustrated in FIG. 1 and is thereby pressed away from the shield member 4 and elastically deformed. When the connector member 5 is inserted farther into the shield member 4, as illustrated in FIG. 1, the stepped portion 521 of the connector member 5 is stopped by the shield-side engaging part 42. With this stopping, the insertion of the connector member 5 into the shield member 4 is complete. At this time, the elastic protrusion 520 gets over the shield-side engaging part 42 and returns to its original shape by its intrinsic elasticity. As a result, the shield-side engaging part 42 is caught between the elastic protrusion 520 and the stepped portion 521. By stopping the shield-side engaging part 42 against the elastic protrusion 520 and the stepped portion 521, the connector member 5 is firmly secured inside the shield member 4.

(First Terminal)

The first terminal 6 may be a male terminal or a female terminal. The first terminal 6 in the present example is a female terminal. As illustrated in FIGS. 13 and 14, the first terminal 6 is provided with a tubular part 6A and a connecting part 6B.

<Tubular Part>

The tubular part 6A is provided with a terminal hole 6h into which a male mating terminal not illustrated is inserted. The female first terminal 6 and the male mating terminal are electrically connected through mechanical contact between the terminals. The female first terminal 6 is obtained by stamping a sheet material. Additionally, the tubular part 6A is provided with a flat spring 60 and a pressing portion 61.

Flat Spring

The flat spring 60 presses against the outer circumferential surface of the mating terminal inserted into the terminal hole 6h. In the present example, the outer circumferential surface of the tubular part 6A includes the outer surface of the flat spring 60. As illustrated in FIG. 14, the flat spring 60 is formed by a portion of the tubular part 6A. Specifically, the tubular part 6A has a rectangular tube shape and is provided with four side surfaces. One of the side surfaces forming the tubular part 6A forms the flat spring 60. Accordingly, the outer surface of the flat spring 60 is exposed as the outer circumferential surface of the tubular part 6A. The end of the flat spring 60 on the terminal hole 6h side and the end of the flat spring 60 on the connecting part 6B side are joined to another side surface forming the tubular part 6A. The two corner portions of the tubular part 6A sandwiching the flat spring 60 are punched out. Consequently, the tubular part 6A has respective through-holes in the two corner portions. The flat spring 60 is curved such that a central portion thereof in the axial direction of the tubular part 6A, or in other words the direction in which the mating terminal is inserted or removed, bulges inward into the tubular part 6A.

Pressing Portion

As illustrated in FIG. 13, the pressing portion 61 is provided on the side surface that faces the flat spring 60. The pressing portion 61 is recessed inward into the tubular part 6A. The pressing portion 61 presses the mating terminal housed in the tubular part 6A against the flat spring 60. As a result, the mating terminal and the flat spring 60 make contact reliably.

The tubular part 6A is obtained easily by stamping. For example, the through-holes are provided by punching out the portions of the sheet material treated as the raw material of the first terminal 6 at the corner portions of the tubular part 6A. By bending the sheet material with the through-holes into a prescribed shape and curving the portion that is to act as the flat spring 60, the tubular part 6A including the flat spring 60 is formed. In a conventional female terminal, a flat spring is formed and then a tubular part is formed to surround the flat spring. For this reason, the outer surface of the flat spring is covered by a side surface of the tubular part. In contrast, in the first terminal 6 in the present example, the flat spring 60 itself forms a portion of the tubular part 6A. For this reason, forming the tubular part 6A to cover the flat spring 60 is unnecessary. Consequently, the first terminal 6 in the present example has superior manufacturability compared to a conventional female terminal. The pressing portion 61 can be formed at the same time as the flat spring 60 when stamping the tubular part 6A.

<Connecting Part>

The connecting part 6B is the portion that is connected to the conductor 20 of the communication cable 2 illustrated in FIG. 5. The connecting part 6B is provided with a wire barrel 62. The wire barrel 62 grips the conductor 20. By causing the wire barrel 62 to grip the conductor 20, the first terminal 6 and the conductor 20 are electrically connected. The first terminal 6 in the present example is provided with only the wire barrel 62 as a barrel for gripping the outer circumference of the communication cable 2. A conventional female terminal is provided with an insulation barrel for gripping the sheath 24 of the communication cable 2, but the first terminal 6 in the present example is not provided with an insulation barrel.

<Engaging Part>

The first terminal 6 is provided with an engaging tab 63. The engaging tab 63 engages with the engaging recess 56 of the connector member 5 illustrated in FIG. 8. The engaging tab 63 is configured by making a cut in a portion of the sheet material forming the first terminal 6 and bending the cut portion. For this reason, the engaging tab 63 is elastic like a flat spring. The tip of the engaging tab 63 points toward the wire barrel 62. The first terminal 6 is inserted into an insertion hole 5h from the base SOB side of the connector member 5 illustrated in FIG. 8. When the first terminal 6 is inserted into the insertion hole 5h, the engaging tab 63 is pressed against the inner circumferential surface of the insertion hole 5h and thereby elastically deformed inward into the tubular part 6A. When the first terminal 6 is inserted farther into the insertion hole 5h, the engaging tab 63 returns to its original shape by its intrinsic elasticity at a position corresponding to the engaging recess 56. The engaging tab 63 having returned to its original shape is caught in the engaging recess 56. Due to this catching, the first terminal 6 is firmly secured to the connector member 5.

<Thickness>

The thickness of each part of the first terminal 6 is preferably less than or equal to 0.15 mm. If the thickness is less than or equal to 0.15 mm, a compact and lightweight first terminal 6 is obtained easily. The shield member 4 formed from a casting as described above tends to be thicker compared to a stamped shield member. To avoid a bulky shield member 4, the connector member 5 and the first terminal 6 disposed inside the shield member 4 are preferably compact.

The thickness of each part of the first terminal 6 is preferably equal to or greater than 0.05 mm. If the thickness is equal to or greater than 0.05 mm, the strength of the first terminal 6 is ensured. The thickness is preferably equal to or greater than 0.075 mm and less than or equal to 0.13 mm, more preferably equal to or greater than 0.080 mm and less than or equal to 0.10 mm. The thickness here does not include the thickness of the edges obtained by bending the sheet material forming the first terminal 6.

<Constituent Material>

The constituent material of the first terminal 6 may be a material with excellent conductivity, typically a metal. The constituent material in the present example is preferably a material of superior strength. This is because, unlike a conventional female terminal, the first terminal 6 in the present example is not provided with a protective part covering the outer circumference of the flat spring 60. Stainless steel is one example of a material with excellent conductivity and superior strength. Stainless steel suitable for the first terminal 6 in the present example may be any of the European standard steel numbers indicated below, for example.

European Standard Steel Numbers

Examples of European standard steel numbers include 1.4372, 1.4373, 1.4310, 1.4318, 1.4305, 1.4307, 1.4306, 1.4311, 1.4303, 1.4401, 1.4436, 1.4404, 1.4432, 1.4435, 1.4406, 1.4429, 1.4571, 1.4438, 1.4434, 1.4439, 1.4539, 1.4541, 1.4550, 1.4587, 1.4381, 1.4462, 1.4507, and 1.4002. Among these steel numbers, 1.4310 and 1.4318, for example, are preferable from the standpoint of conductivity and strength.

The surface of the first terminal 6 is preferably provided with a plating layer formed from a material with excellent conductivity. The constituent material of the plating may be tin (Sn), tin alloy, silver (Ag), or silver alloy, for example.

The first terminal 6 in the present example is not provided with a configuration for covering the outer portions of the flat spring 60 and the pressing portion 61, and therefore has a simpler configuration than a conventional female terminal. For this reason, when manufacturing the tubular part 6A by stamping, the flat spring 60 and the pressing portion 61 can be formed at the same time. The first terminal 6 in the present example as above can be produced more easily than a conventional female terminal.

(Outer Housing)

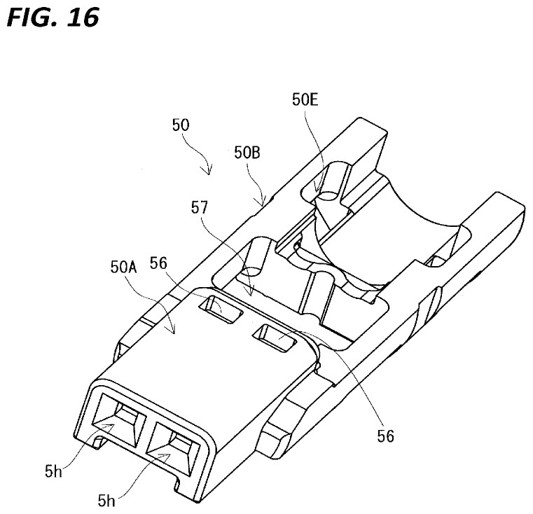

As illustrated in FIG. 15, the connector assembly 9 in the present example is provided with an outer housing 90. The outer housing 90 includes the housing part 95 illustrated in FIG. 1 and described above. The outer housing 90 houses the communication cable 1 with a connector illustrated in FIGS. 1 and 3 and the signal cable unit 8 illustrated in FIG. 15. FIG. 15 is a schematic front view of the outer housing 90 as seen from the side on which the first terminals 6 described above and the second terminals 80 of the signal cable unit 8 described later are exposed.

The signal cable unit 8 is provided with a signal cable not illustrated that transmits electrical signals, a plurality of second terminals 80, and an inner housing 81 that houses the plurality of second terminals 80. In the present example, the first terminals 6 are female terminals, and therefore the second terminals 80 are also female terminals. In the case where the first terminals 6 are male terminals, the second terminals 80 are also male terminals. The outer housing 90 in the present example collectively houses the communication cable 1 with a connector and the ends of the signal cable unit 8. The outer housing 90 collectively houses the connector module 3 of the communication cable 1 with a connector and the inner housing 81 of the signal cable unit 8.

The outer housing 90 in the present example is further provided with a tubular part 91 and a partition 92. The tubular part 91 forms the exterior of the outer housing 90. The partition 92 divides the interior of the tubular part 91 into multiple sections. In the outer housing 90 of the present example, by partitioning the interior of the tubular part 91 with the partition 92, a space housing the communication cable 1 with a connector and a space housing the signal cable unit 8 are provided.

The connector assembly 9 provided with the communication cable 1 with a connector makes it easy to construct a communication environment in an automobile. By connecting the connector assembly 9 in the present example to a male connector assembly not illustrated which is provided on a circuit board of an in-vehicle device, a transmission route for the signal cable and a transmission route for the communication cable 2 are established at the same time.

When the communication cable 1 with a connector is housed in the outer housing 90 of the present example, the ridges 30p of the watertight plug 30 illustrated in FIGS. 1, 3, and 5 closely contact the inner circumferential surface 96 of the housing part 95, and the recess 30c of the watertight plug 30 is caught on the raised section 97 of the housing part 95. The watertight plug 30 is positioned by this catching. Also, the close contact between the ridges 30p and the inner circumferential surface 96 of the housing part 95 deters the entry of environmental water into the connector module 3 from between the communication cable 1 with a connector and the outer housing 90.

The total number of first terminals 6 and second terminals 80, or in other words the number of poles, is preferably equal to or greater than 20 and less than or equal to 200. If the number of poles is equal to or greater than 20, many transmission routes are established at once through the connection with the connector assembly 9. If the number of poles is less than or equal to 200, the connection resistance when connecting the female connector assembly 9 of the present example to a male connector assembly is not overly high. Accordingly, both the connector assemblies are connected easily.

The pitch of the second terminals 80 is preferably equal to or greater than 0.1 mm and less than or equal to 2.0 mm. If the pitch of the second terminals 80 is within this range, a compact connector assembly 9 is obtained easily. If the connector assembly 9 is compact, a connector assembly 9 of a size corresponding to a male connector assembly provided on a circuit board can be produced.

### Modification 1

[Connector Assembly]

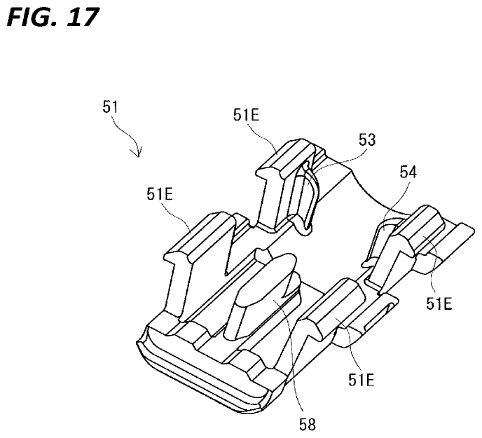

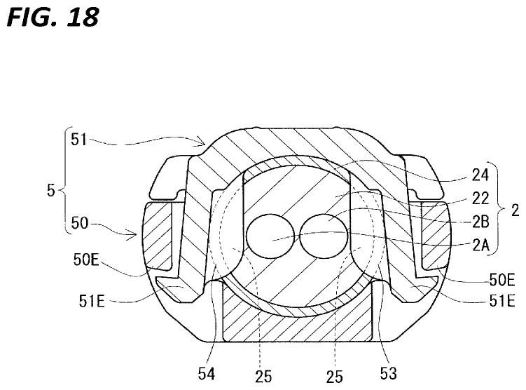

FIGS. 16 to 18 will be referenced to describe a connector assembly according to Modification 1. In the connector assembly according to Modification 1, the configuration of the clamps 53 and 54 differs from the connector assembly according to Embodiment 1. The following description primarily focuses on the differences from Embodiment 1. A description of the portion of the configuration that is similar to Embodiment 1 will be omitted. FIG. 16 is a perspective view of the housing 50 of the connector member 5 as seen from the inner circumferential side. FIG. 17 is a perspective view of the cover 51 of the connector member 5 as seen from the inner circumferential side. FIG. 18 is a sectional view of the communication cable 1 with a connector taken in the direction orthogonal to the longitudinal direction at the position where the clamps 53 and 54 are provided. Like FIG. 12, FIG. 18 illustrates a configuration in which the communication cable 2 is provided with the intervening layer 22 between the insulating layer 21 and the sheath 24 out of convenience, but as described in Embodiment 1, the intervening layer 22 does not have to be provided.

As illustrated in FIG. 16, the housing 50 in the present example is not provided with a clamp on the inner circumferential surface of the base 50B. As illustrated in FIG. 17, the cover 51 in the present example is provided with two clamps 53 and 54 on the inner circumferential surface thereof. The clamps 53 and 54 are provided apart from each other in the width direction of the cover 51. Specifically, the clamp 53 is provided on the inner circumferential surface of one of the two cover-side engaging parts 51E on the trailing-end side of the cover 51. The clamp 54 is provided on the inner circumferential surface of the other cover-side engaging part 51E. The clamps 53 and 54 are both integrally joined to the cover 51. Accordingly, the clamps 53 and 54 also function as reinforcing members for the cover-side engaging parts 51E.

The clamps 53 and 54 are curved plate-like members. Each curved plate is provided so as to be convex in the opposite direction from the partition 58. The leading ends of the clamps 53 and 54 are disposed closer to the partition 58 than the bases of the clamps 53 and 54, which is the diagonally lower side of the page in FIG. 17. Also, the leading ends of the clamps 53 and 54 are disposed pointing toward the first terminal 6 illustrated in FIG. 5.

As illustrated in FIG. 18, in the communication cable 1 with a connector using the connector member 5 of the present example, the clamps 53 and 54 provided on the cover 51 catch the communication cable 2 from the outer circumference. At this time, the clamps 53 and 54 bite into the notches 25 provided in the intervening layer 22. With this configuration, too, the connector member 5 is firmly secured on the end of the communication cable 2. In the present example, the thickness of the clamps 53 and 54 decreases proceeding from the bases to the tips of the clamps 53 and 54. For this reason, the clamps 53 and 54 easily bite into the notches 25.

### LIST OF REFERENCE NUMERALS

1: communication cable with a connector
2: communication cable, 2A, 2B: electric wire
20: conductor, 21: insulating layer, 22: intervening layer
24: sheath, 25: notch
3: connector module
30: watertight plug, 30c: recess, 30p: ridge
4: shield member, 4A: tubular body, 4B: connecting part
40: opening, 42: shield-side engaging part, 43: thick-walled section, 46: opening
5: connector member, 5h: insertion hole, 50: housing
50A: connector tube, 50B: base, 50E: housing-side engaging part
51: cover, 51E: cover-side engaging part
52: connector-side engaging part, 520: elastic protrusion, 521: stepped portion
53, 54: clamp, 56: engaging recess, 57: through-hole
58: partition, 59: arched portion
6: first terminal, 6A: tubular part, 6B: connecting part, 6h: terminal hole
60: flat spring, 61: pressing portion, 62: wire barrel, 63: engaging tab
8: signal cable unit, 80: second terminal, 81: inner housing
9: connector assembly, 90: outer housing
91: tubular part, 92: partition, 95: housing part, 950: opening
96: inner circumferential surface, 97: raised section, 971: first surface

1. A connector assembly comprising:
a communication cable;
a tubular watertight plug; and
a housing part, wherein
the watertight plug is mounted onto an outer circumferential surface of the communication cable,
the housing part has
a tubular inner circumferential surface covering an outer circumference of the watertight plug, and
a raised section projecting out from the inner circumferential surface toward the watertight plug, and
the raised section catches the watertight plug so as to oppose a slip-off direction of the watertight plug from the housing part.

2. The connector assembly according to claim 1, wherein
the raised section has a first surface provided on a side opposite from the slip-off direction, and
the first surface has at least one of an orthogonal surface that is orthogonal to the slip-off direction or an inclined surface that is inclined toward the opposite side proceeding toward the watertight plug.

3. The connector assembly according to claim 2, wherein
the watertight plug has a recess that is caught on the raised section, and
the recess has a surface that abuts the first surface of the raised section.

4. The connector assembly according to claim 1, wherein the housing part has a plurality of raised sections.

5. The connector assembly according to claim 1, wherein
the communication cable includes a conductor, an insulating layer, and a sheath in order from the inside out,
the connector assembly includes
a first terminal electrically connected to the conductor exposed from the sheath,
a connector member that houses the first terminal, and
a tubular shield member that covers the outer circumference of the connector member and the outer circumference of the sheath, and
the watertight plug is mounted onto the outer circumferential surface of the sheath exposed from the shield member of the communication cable.

6. The connector assembly according to claim 5, wherein the communication cable is an unshielded twisted-pair cable.

7. The connector assembly according to claim 5, wherein the shield member is a casting.

8. The connector assembly according to claim 5, wherein
the connector member includes a clamp projecting out from the inner circumferential surface of the connector member, and
the clamp bites into the communication cable.

9. The connector assembly according to claim 5, wherein
the first terminal is provided with
a tubular part into which a male terminal is inserted, and
a connecting part electrically connected to the conductor,
the tubular part comprises a flat spring that presses against the outer circumferential surface of the male terminal inserted into the tubular part, and
the outer circumferential surface of the tubular part includes the outer surface of the flat spring.
